(19) United States
(12) Patent Application Publication
(10) Pub. No.: US 2010/0047089 A1
(43) Pub. Date: Feb. 25, 2010

(54) HIGH TEMPERATURE MONITORING SYSTEM FOR ESP

(75) Inventors: John Booker, Missouri City, TX (US); Allan Ross, Houston, TX (US); Harryson Sukianto, Missouri City, TX (US); Alain Dorel, Houston, TX (US); Arthur Watson, Sugar Land, TX (US); Albert Kyin, Missouri City, TX (US); Anthony Veneruso, Sugar Land, TX (US)

Correspondence Address: Patent Counsel;Schlumberger Reservoir Completions, Schlumberger Technology Corporation, 14910 Airline Road, Rosharon, TX, 77583, US

(73) Assignee: SCHLUMBERGER TECHNOLOGY CORPORATION, Sugar Land, TX (US)

(21) Appl. No.: 12/346,434

(22) Filed: Dec. 30, 2008

Related U.S. Application Data
(60) Provisional application No. 61/090,445, filed on Aug. 20, 2008.

(51) Int. Cl. F04B 35/04; G01K 7/02; G01K 13/00; E21B 43/00; E21B 47/00

(52) U.S. Cl. 417/410.1; 374/179; 374/143; 374/141; 166/250.01; 374/E07.004; 374/E13.001

(57) ABSTRACT

An electric submersible pump device, comprising an electric motor having stators and coils; a pump coupled with the electric motor; a thermocouple or RTD for measuring temperature of the motor windings.

### PRIORITY

The present application claims priority to and incorporates in its entirety, Provisional Application No. 61/090,445, filed on Aug. 20, 2008.

### TECHNICAL FIELD

The present application generally relates to high temperature monitoring of an electric submersible pump.

### BACKGROUND

Subterranean fluids are desirable for extraction. These fluids are often water, oil, or natural gas. Alternatively, it is often desired to inject fluids and gases into subterranean regions for various reasons.

To access subterranean regions, wells are created. Generally, in the hydrocarbon industry, wells are drilled from surface into formation. Those wells are cased with a metal casing. In order to access the formation surrounding the casing from within the casing in order to retrieve formation fluids (oil/water/natural gas), perforations are creating through the casing.

It is often times advantageous to use an electric submersible pump to help deliver fluids from downhole to surface. An electric submersible pump includes an electric motor coupled with a pump.

In connection with that activity, many issues arise. Some of those issues are described and addressed in the present application.

### SUMMARY

An embodiment in the present application relates to an electric submersible pump device, comprising an electric motor having stators and coils; a pump coupled with the electric motor; a thermocouple or RTD for measuring temperature of the motor windings.

### BRIEF DESCRIPTION OF THE DRAWINGS

The following is a brief description of the figures contained herein.

FIG. 1 shows an embodiment of a wiring for an RTD and Pressure/Temperature sensor.

FIG. 2A shows an embodiment of a Motor winding RTD/Thermocouple and Pressure-temperature sensor placement into an ESP.

FIG. 2B shows an embodiment of a motor winding RTD/Thermocouple placement into the ESP.

FIG. 3 shows an embodiment of an RTD/Thermocouple at a top of a motor.

FIG. 4 shows an embodiment of an RTD/Thermocouple at a top of the motor, integrated with an BH P/T sensor.

FIG. 5 shows an embodiment of a BH P/T sensor and RTD/Thermocouple connected at a bottom of the motor.

FIG. 6 shows an embodiment of a BH P/T sensor and RTD/Thermocouple connected between motor and compensator.

FIG. 7 shows an embodiment of a BH P/T sensor and RTD/Thermocouple connected below the Compensator.

FIG. 8 shows an embodiment with a motor winding temperature versus ESP pump production rate.

FIG. 9 shows an embodiment having a motor life expectancy versus motor winding temperature.

FIG. 10 shows an embodiment having a simplified circuit diagram of synchronous switching for error cancellation.

FIG. 11 shows an embodiment having a signal diagram of synchronous switching for error cancellation.

### DETAILED DESCRIPTION

The following description relates to various features of embodiments described in the present application. The description is meant to facilitate understanding of the embodiments and is not meant to limit either any of the present claims herein or any future related claims.

The present application relates to a High Temperature Monitoring System (HT Monitoring System) for an Electrical Submersible Pump (ESP). For example, the HT Monitoring System could be used in wells with bottomhole temperatures between approximately 150° C. and 250° C. (302-482° F.), a.

Embodiments of an HT Monitoring System can improve ESP run life by monitoring motor winding temperature in real time. Therefore, ESP operation can be adjusted to maintain motor winding temperature below its limit. The HT Monitoring System can also optimize production and overall steam to oil ratio (SOR) by monitoring internal motor temperature versus production rate or steam injection, thereby allowing production and steam injection optimization.

The HT Monitoring tool can use a downhole pressure-temperature gauge and resistance temperature device (RTD), which are wired to the electronic processing board located at surface using a 7-wire conductor armored cable.

Preferred embodiments have the following technical preferences for the HT Monitoring tool:
Interface with ESP motor.
Maximum OD 4.50″ to work with 4.56″ OD motor, or max 5.60″ OD for use with 5.62″ OD motors.
Work in vertical or horizontal wells.
Same DLS requirements as standard ESP.
Bottomhole temperature 250° C. (482° F.)
Maximum Pressure rating 5,000 psia.
Ability to operate over a full temperature cycle (including temperature spikes) including ambient well conditions, well steaming and max operating temperature.
Metallurgy of Carbon Steel or 9Cr alloy.
Monitor Bottomhole Pressure, Bottomhole Temperature, and Motor Winding Temperature
Pressure sensor Accuracy: +/−1 psi, Resolution: 1 psi at 1 minute averaging per measurement, Drift: +/−20 psi/year
Temperature sensor Accuracy: +/−3 degc, Resolution 1 degc at 1 minute averaging per measurement
Transmission rate 1 per minute.

As noted above, the present application includes embodiments relating to is a series of technologies that enable high temperature ESP monitoring. The present application relates to a system using a downhole pressure-temperature sensor for bottom hole pressure (BHP) and bottom hole temperature (BHT) monitoring, and a stand alone temperature sensor (thermocouple or RTD) for motor winding temperature monitoring, connected through 7-wire conductor armored cable to an electronic processing board at surface. It is also possible to connect only the motor winding temperature sensor without the downhole pressure-temperature sensor to the electronic processing board using 2, 4 or 7 wire conductor armored cable.

One way of thermocouple or RTD for HT motor winding temperature monitoring is to attach the thermocouple or RTD to the bottom end of a motor stator (at motor base). In that case, the thermocouple or RTD can be inserted in the motor oil around the winding end-turns but not attached to anything, or attached to the winding end-turns. There, the temperature measured is not as representative of the motor winding temperature as possible. Therefore, the present application includes attaching a thermocouple or RTD inside a winding slot of the motor windings. It is also advantageous to insert the thermocouple or RTD from the top of the motor (motor head) at or around the pothead or the opposite side of the pothead.

The bottomhole pressure-temperature sensor is typically mounted above the ESP pump or below the ESP motor. There are some issues associated with these constructions, and therefore it is beneficial to mount the sensor between the ESP motor and ESP compensator, or below the ESP compensator.

The motor winding temperature data can be used to optimize ESP operation and increase ESP run life in Steam Assisted Gravity Drainage (SAGD) recovery method. This method is advantageous over other designs used in conventional oil wells, which mainly uses bottomhole pressure. Motor winding temperature is used to trip the motor when it is overheated. The present application has a methodology for using motor winding temperature to optimize ESP operation in SAGD.

An aspect of the present application relates to analog and digital processing techniques to filter ESP noise and electrical system errors.

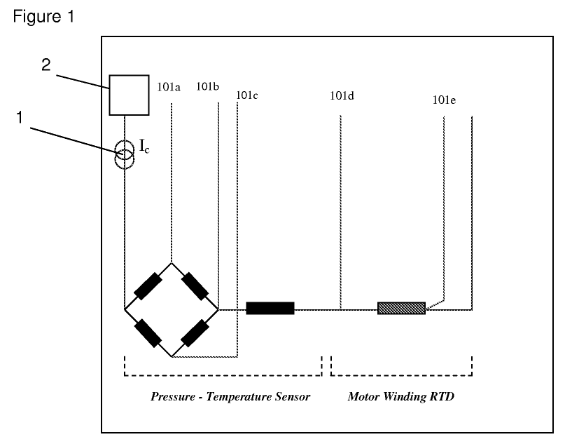

Looking at the specific embodiments now, FIG. 1 illustrates the wiring of a HT Monitoring System pressure-temperature sensor together with an RTD/Thermocouple using a 7-wire conductor cable. A constant current, Ic 1, supplied from a controlled source 2 at surface (shown at the left side of the circuit diagram), is made to flow through the RTD and the bridge in a series circuit. The voltage across each of these components is independently connected to surface by conductors 101a-e that permit their voltage drops to be measured independently by high impedance voltmeters at surface (not shown). Since the current through each device is known, the resistance of each device can be calculated by dividing the respective voltage by the constant current Ic.

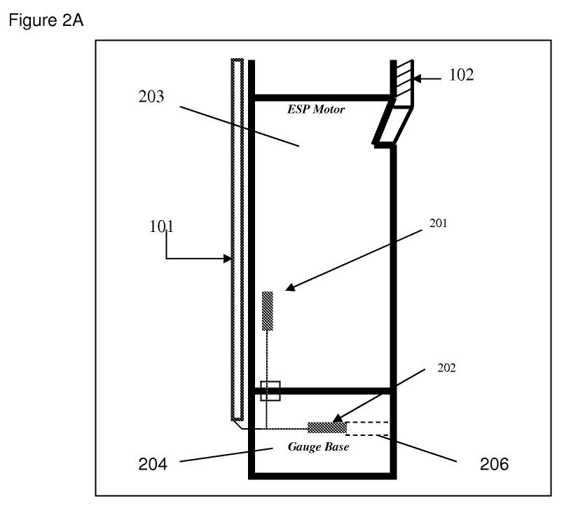

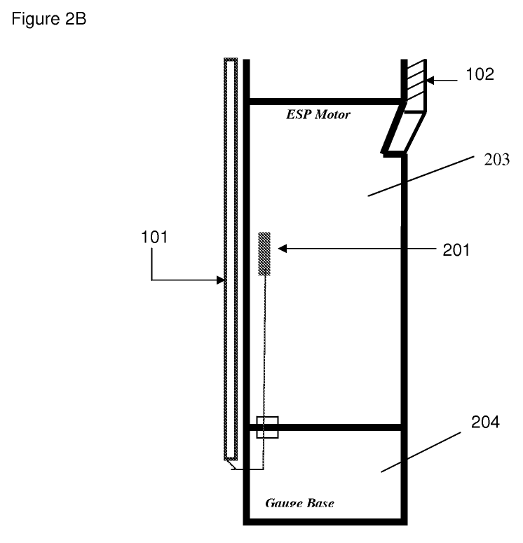

The integration or placement of these sensors into an ESP unit is shown in FIGS. 2A and 2B. FIG. 2A shows a motor winding RTD/Thermocouple 201 and pressure-temperature sensor 202 placement into the ESP 203. FIG. 2A shows that the P/T sensor 202 is mounted inside an adaptor 204 (Gauge Base). However, the sensing side of the sensor is connected to the wellbore 205 via communication path 206 illustrated by the dotted lines. The sensing side can also be located at the wall of the Base 204 and therefore connected directly to wellbore 203. The RTD/Thermocouple 201 is located inside the ESP motor 203. The Gauge Base (and Gauge Sub) is oil or air filled inside with no communication with wellbore fluids.

FIG. 2B shows a RTD/Thermocouple 201 for motor winding temperature monitoring. This aspect is basically a simplified version of that previously noted in connection with FIG. 2A. The RTD 201 essentially needs only 4-wires, and alternatively a thermocouple only needs 2-wires, to connect to the surface electronic processing board.

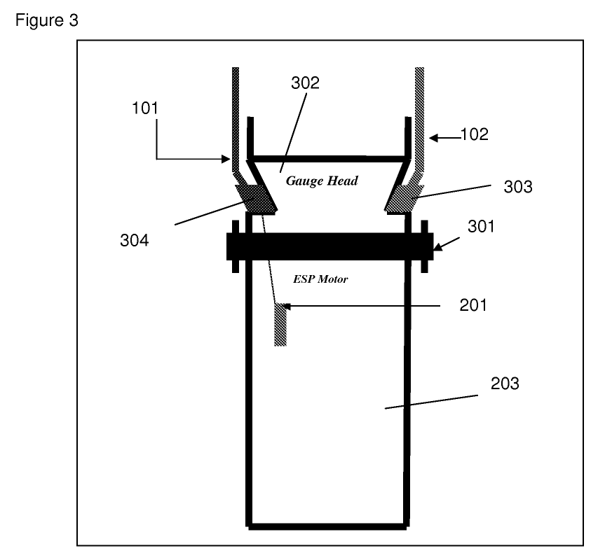

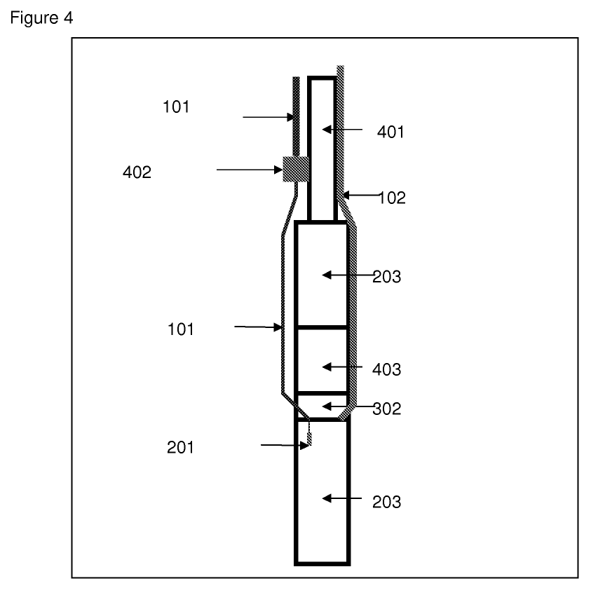

FIG. 3 shows an RTD/Thermocouple 201 at the top of the motor. This construction has a gauge head 302 which accommodates both pothead 303 and the sensor penetrator 304. The sensor penetrator 304 is located at the opposite side of the pothead 303. The gauge head 302 is connected to the motor 203 with a flange connection 301, which allows the alignment of sensor wire during make up/connection. This construction can also be used to integrate with a BHP and BHT sensor with the wiring as shown in FIG. 1. However the BHP and BHT sensor can be located above the ESP 203 as shown in FIG. 4.

FIG. 4 shows a BHP and a BHT sensor and RTD/Thermocouple 201 connected at the top of the motor 203. A gauge head 302 is above the motor 203. An ESP protector 403 is above the gauge head 302 and below the ESP pump and intake 203. The ESP pump and intake 203 is connected with production tubing 401. A BHP and BHT sensor 402 is connected above the ESP pump and intake 203.

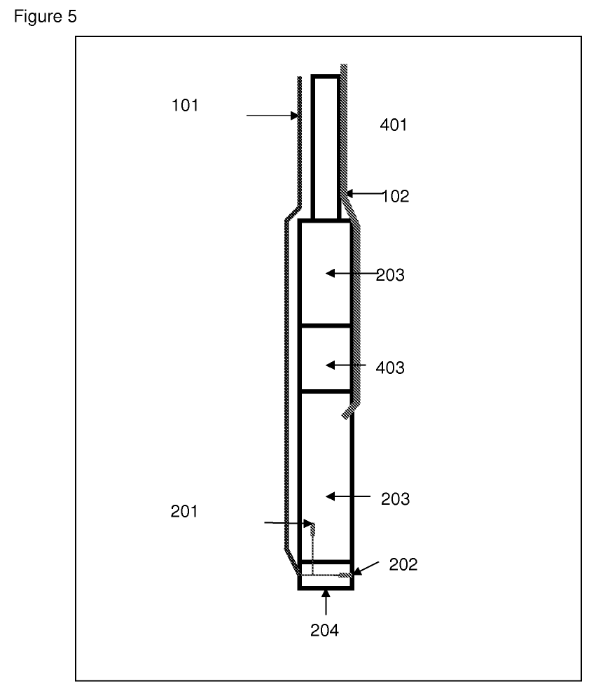

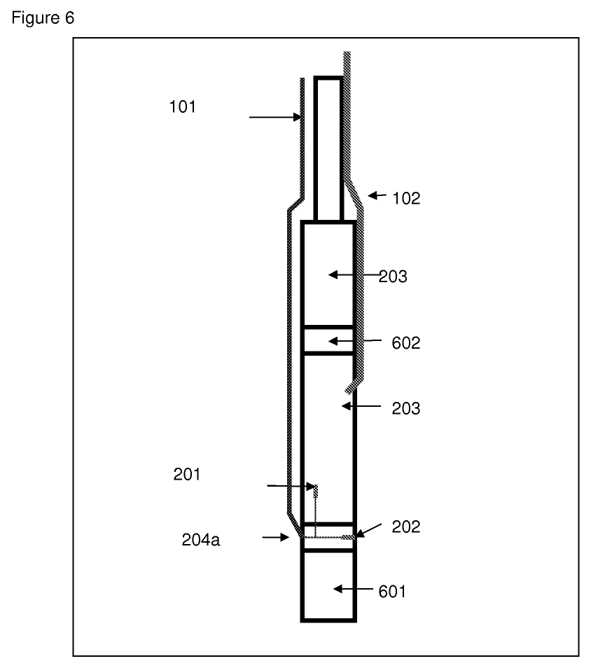

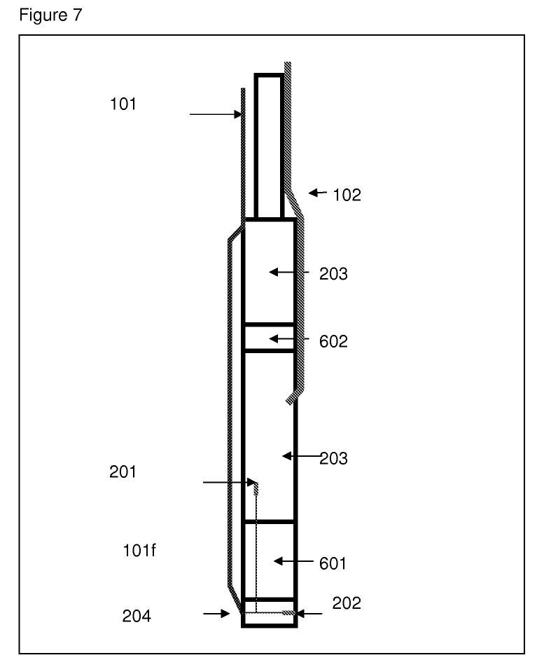

FIG. 5 shows the BHP and BHT sensor 202 and RTD/Thermocouple 201 connected at the bottom of the motor 203. This type of construction can be applied to existing ESP designs. However the protector design separates out the shaft seal section (Seal Sub) from the pressure compensating section (Compensator). According to the present application ESP, the monitoring system can be mounted in the following ways:
a. Between the Motor 203 and above the Compensator 601 (see FIG. 6).
b. Below the Compensator 601 (see FIG. 7). In this case the wires 101f for RTD/Thermocouple 201 will pass through inside the Compensator 601.

FIG. 6 shows a gauge sub 204a, i.e., a cable-to-surface/CTS portal. The CTS portal 204a provides a sealed field-entry point for a cable-to-surface for sensors or gauges. Preferably, the ¼″ armored cable enters at a notch in the side of the portal and is sealed with a swaged ferrule and redundant o-rings. The redundant o-rings are equipped with anti-extrusion rings because high pressure differential can be developed. The ferrule gland nut screws into a larger bulkhead fitting that plugs a hole sufficiently large for the electrical connectors pre-attached to the cable to pass through.

The flange at the lower end of the CTS portal connects to the motor compensator 601. This flange will be temporarily opened during field installation to facilitate connection of the CTS cable to the wires of the RTD/Thermocouple in the motor windings (and to the wires of the pressure gauge, if present). A reason for breaking and remaking this flange joint in the field is that the small gauge wires used in the cable are sometimes not stiff enough to reliably stab into an external port, because they tend to buckle. A reliable way to connect such small gauge wires is by holding the connector from the CTS in one hand and plugging it into the connector from the RTD held in the other hand. Then the connectors and wires are sealed in a wire cavity. A small wire cavity in the side of the equipment would be expensive to make and tricky to seal. The largest, cheapest and most reliably sealed wire cavity is actually a flange joint between ESP components.

The CTS portal is convenient because both sets of wires (the cable and the RTD/Thermocouple) are immobilized in and extend from the lower face of the same component (the portal), making it very easy to plug-in the connectors without fighting to control relative movement of two ESP components, which could strain the connection.

The threaded upper end of the CTS portal is screwed into the lower end of the stator housing or bolted to an intermediate part. In this embodiment, there is no need for a shaft extension or base bushing in the CTS portal.

The RTD/Thermocouple wires 101f coming from the motor pass through a hole in the center of the portal and are sealed by a rubber plug to prevent oil loss when the flange is opened in the field. The wire hole in the center to avoid twisting the wires while screwing on the base.

A poppet valve provides oil communication between the portal and the compensator but closes to prevent oil loss when the flange is opened in the field. A valve actuator pin in the upper end of the compensator opens the poppet when the flange is made up. To ensure the correct angular orientation of the valve in the portal with the valve actuator in the compensator, a pin (the head of a bolt) in the compensator flange face should mate with a corresponding hole in the face of the portal flange.

A pressure gauge may be added to the portal. The pressure gauge would screw into the lower face of the portal and seal to a port on the side of the portal. The wiring would join the RTD/Thermocouple wiring in a single connector.

A procedure for installation of the CTS with a fully integrated Motor-Compensator can be as follows.
In the shop, the ferrule gland nut is pre-swaged to the cable armor and the bulkhead fitting. Also, the electrical connector is pre-attached to the cable.
At the wellsite, the Motor is picked up from the box and lowered to the wellhead. The Compensator is either held in the slips or held with a shoulder clamp on the work table.
The Compensator flange joint is un-bolted and the Motor is lifted up approximately 1 to 2 ft from the Compensator. This exposes the RTD/Thermocouple electrical wire and connector hanging from the center of the flange. The flange can be a MaxJoint style with a poppet valve to prevent loss of oil from the motor.
The shipping plug is removed from the CTS port. The cable with its fittings and connector is inserted into the CTS port. The cable electrical connector passes through the flange and hangs from the lower face of the flange. The bulkhead fitting and the gland nut are tightened.
The cable and RTD/Thermocouple connectors are joined and the wires are bundled with tie wraps to avoid pinching when the flange is made up.
The Compensator is topped up as required by simply pouring oil into the open flange.
The Motor is lowered and bolted to the Compensator with the wiring enclosed. As the flanges come together, oil will overflow and the poppet valve will open.

The present application relates to a methodology for ESP optimization in SAGD which is not based on reservoir pressure and productivity index but based on bottomhole temperature and motor winding temperature.

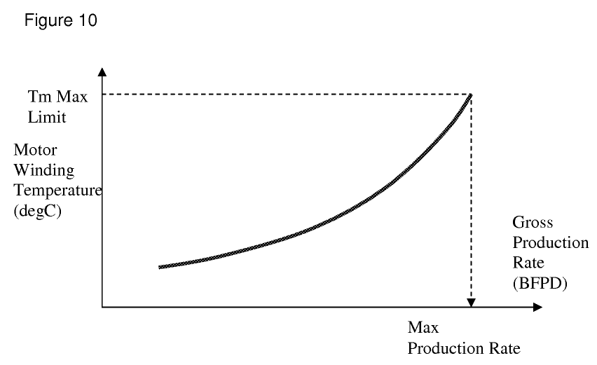

Unlike in oil well with static BHT temperature, in SAGD, bottomhole temperature (BHT) changes, depending on production rate and steam injection pressure/temperature at the injector well. With the same steam injection pressure/temperature, higher production rate will cause higher BHT. The main limitation of ESP in SAGD operation is the temperature limit of the ESP. The hottest spot in the ESP unit is inside the motor, around the rotor and stator winding. Production rate of the ESP can be increased (e.g., by increasing frequency) but the motor winding temperature will also increase at the same time. Therefore the production limit will be reached when the motor winding temperature hits the maximum limit/rating. FIG. 10 illustrates this principle.

However, it may not be desirable to produce at this temperature limit because the life of the motor will be shorter (i.e. as per supplier's warranty time, normally 1 year).

The life of the motor is closely related to the motor winding temperature. The general equation that governs the relationship is the Arrhenius equation.

k=Ae^{-E}^{ₐ}^{/RT} (Simple form)

k=A(T/T₀)ⁿe^{-E}^{ₐ}^{/RT} (Modified Form)

It is a simple, but remarkably accurate, formula for the temperature dependence of the rate constant, and therefore rate, of a chemical reaction. The general rule of thumb, without solving the equation, is that for every 10° C. increase in temperature the rate of reaction doubles. It means that the life expectancy of the motor becomes half of the original life expectancy. As with any rule of thumb, it does not always as accurate as required, but generally gives a qualitative guideline.

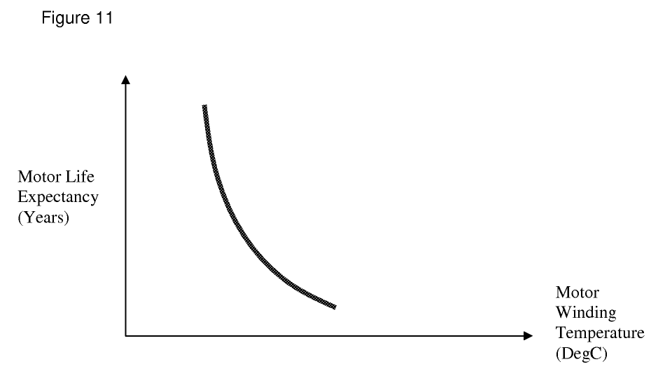

For example: if the motor winding temperature is rated at 287 degc and the supplier warranty is 1 year, one can assume the life expectancy of the motor is 1 year at 287 degc winding temperature. If the motor is run at winding temperature 277 degc, then the life expectancy of the motor becomes 2 years and so on. The graph in FIG. 11 illustrates this relationship. Essentially, running at higher motor winding temperature will yield higher production rate (thus higher Total Revenue) but the motor life is also sacrificed at the same time, and therefore more number of workover and ESP unit used (thus higher Total Cost). The two relationships in FIGS. 10 and 11 can be used to find the optimum operating point, which maximizes net cash-flow over certain period of time.

Looking now at analog and digital processing techniques to filter ESP noise, it is noted that several key problems can be addressed in order to successfully measure an analog voltage across a device connected by long wires down inside a well equipped with an ESP motor.

First, the resistance of the interconnecting wires changes as a function of the length of cable employed and the actual temperature profile of the wire along its length. Typically, this temperature profile is not known. FIG. 1 illustrates a modified version of a four-wire resistance circuit in which a constant current source at surface is connected to supply current to each sensor device and how two other wires are used to measure the voltage across each device independently. If the voltage measuring wires are connected to high impedance voltmeters then the current drop through the voltage wires is negligible. Therefore the resistance of the interconnecting wires may be ignored and the voltage measured at surface will be approximately equal to the voltage across the respective sensor device.

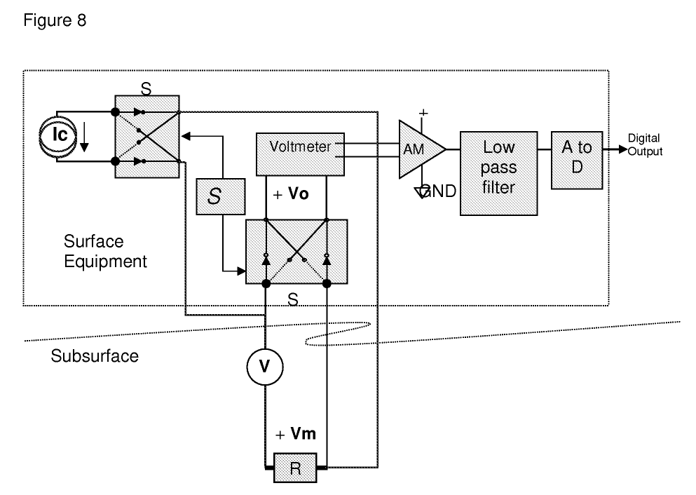

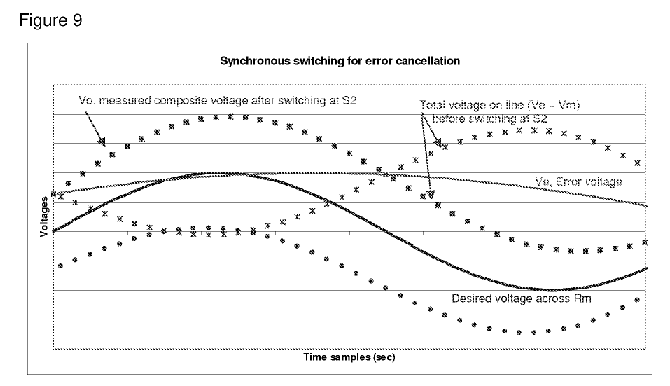

Another issue is unwanted electric voltages that may be generated on the voltage measuring wires connected to surface due to thermocouple effects caused by dissimilar metallic junctions at different temperatures in the circuit wiring. This thermocouple, or Seebeck effect can generate large DC voltage errors that are significant compared to the desired voltages being measured. FIG. 8 illustrates a simplified circuit to help describe the solution to this problem. In this circuit the polarity of both the input controlled current source, Ic, and output voltage measurement, Vo, are switched synchronously by switches S1 and S2 under the control of the same oscillator Sw. The voltage across the sensor Rm is proportional to the applied controlled current Ic whereas the Seebeck effect generates an unknown but unidirectional error voltage, Vn that is effectively independent of the applied current Ic. This error voltage is essentially cancelled out when the output voltage Vo is low pass filtered before being converted to a digital signal. The signal diagram shown in FIG. 9 illustrates how the total voltage on the line before switching at S2 is the sum of the error voltage, Ve, and the desired voltage, Vm, across Rm. Note that after switching at S2, the voltage samples are symmetrical about the desired measurement voltage across Rm. After filtering in the low pass filter, the average value, or low frequency signal portion of this composite voltage is equal to the desired measurement voltage Vm across the sensor Rm.

The preceding description of preferred embodiments is meant to aid in the understanding of preferred embodiments and is meant in to way to limit the scope of the claims recited herein.

1. An electric submersible pump device, comprising:
an electric motor having stators and coils;
a pump coupled with the electric motor;
a thermocouple or RTD for measuring temperature of the motor windings.

2. The electric submersible pump device of claim 1, comprising: a bottom hole pressure sensor coupled therewith.

3. The electric submersible pump device of claim 1, comprising: a bottom hole temperature sensor coupled therewith.

4. The electric submersible pump of claim 1, wherein the thermocouple or RTD is at the bottom end of a stator or the motor.

5. The electric submersible pump of claim 1, wherein the thermocouple or RTD is inserted in motor oil surrounding the motor windings.

6. The electric submersible pump device of claim 1, wherein the thermocouple or RTD is inside a winding slot of the motor windings.

7. The electric submersible pump device of claim 7, wherein the thermocouple or RTD is inserted from the top of the motor.

8. The electric submersible pump device of claim 3, wherein the bottom hole temperature sensor is mounted above the pump.

9. The electric submersible pump device of claim 3, wherein the bottom hole temperature sensor is mounted below the motor.

10. The electric submersible pump device of claim 3, wherein the bottom hole temperature sensor is mounted between the motor and the pump.

11. The electric submersible pump device of claim 3, wherein the bottom hole temperature sensor and the thermocouple or RTD is connected using a 7-wire conductor cable.

12. The electric submersible pump device of claim 1, comprising a power cable coupled with the electric submersible motor, and a cable to surface portal that provides an entry point for the power cable.

13. A method for optimizing an electric submersible pump device, the electric submersible pump device including a pump and an electric submersible motor couple with the pump, the method comprising:
detecting bottom hole pressure and detecting motor winding temperature;
optimizing performance of the electric submersible pump device based on the detected bottom hole pressure and detected motor winding temperature.

14. The method of claim 13, wherein the detected winding temperature is used to determine that the motor is overheated and to correspondingly stop the motor.

15. The method of claim 13, wherein a current is supplied from a controlled source at surface, the current being a constant current.

16. The method of claim 13, comprising: detecting bottom hole pressure.

17. The method of claim 16, comprising: optimizing the electric submersible pump device performance based on the detected bottom hole pressure.

18. The electric submersible pump device of claim 1, wherein the pump is a centrifugal pump.

19. The electric submersible pump device of claim 18, wherein the pump comprises a plurality of impellers and a plurality of diffusers.
